(19) United States
(12) Patent Application Publication
(10) Pub. No.: US 2009/0021100 A1
(43) Pub. Date: Jan. 22, 2009

(54) Stator Structure of External-rotor Motor

(76) Inventor: Sheng-Chung LEE, Kaohsiung Hsien (TW)

Correspondence Address: SINORICA, LLC, 528 FALLSGROVE DRIVE, ROCKVILLE, MD, 20850, US

(21) Appl. No.: 11/780,330

(22) Filed: Jul. 19, 2007

(51) Int. Cl. H02K 3/04; H02K 3/28

(52) U.S. Cl. 310/208

(57) ABSTRACT

An improvement on the stator structure of external-rotor consists of the start-up coils and operating coils wound into the silicon steel race, wherein the said silicon steel race comprises a plurality of insulation columns and rabbets, and each insulation column has a wall formed at its external edge thereof, and more over, the said start-up coil is being wound-up, according to the clockwise sequence, at two rabbets positioned at each side of the datum point in an equal-length distance respectively thereto, in order to construct four sets of start-up coils by means of two corresponding sets of cross coils; in addition, there are another four sets of operating coils constructed at the top and bottom of datum point respectively, which are wound-up by means of two corresponding sets of cross coils in an equal-length distance respectively thereto, and thereat the said four sets of operating coils are covering onto the external edge of said start-up coils, so that both the start-up coils and operating coils will be uniformly distributed within the wall of said silicon steel race and in this way it will be able to protect and save its coil quantity and, thus acquire a practical effect on reducing the production costs and saving the electricity consumption.

### BACKGROUND OF THE INVENTION

1. Field of the Invention

The present invention relates to an improvement on the stator structure of external-rotor, particularly to a kind of stator structure applicable to the performance of a rapid winding operation, the saving in the coil quantity of resistance enamelled wire as well as a safe and uniform layout.

2. The Prior Arts

The coil wing method used for resistance enamelled wires in a traditional motor is very complicated, because the space required for receiving the silicon steel sheet iron core of the stator should be large enough, and as a result, the area of silicon steel sheet iron core of the stator should be enlarged as well due to the production reasons; more over, with a poor design for the winding method, it has to add several additional stages in actual production process accordingly.

First, the rabbet used for the known stator is a kind of asymmetry design, which requires performing the winding procedure twice and hence wasting lots of working hours.

Second, due to the known stator has asymmetry rabbets, therefore it is impossible to obtain the coil type with an uniform symmetrical winding, and hence it is required an additional procedure in flatting coil again, which is not only more complicated but also tends to have more damaged coils during the manufacturing process.

Third, the known stator coil has a two-coils type, which can produce a smaller energized magnetic field only, so it needs a relative larger electric current in operation, and hence waste lots of electrical power consequently.

Due to the above imperfections caused from the known stator structure, so there is another design for the traditional stator structure in order to solve all the known imperfections of stator. However, the said traditional stator structure has a silicon steel race consisting of six sets of start-up coils and six sets of operating coils wound-up thereto, where upon the production process, due to much more quantity of coils, therefore it would not only result in the silicon steel race with an exceeding volume, but also creating an additional production cost relatively due to extra quantity of coils, and furthermore, resulting in a slower accomplishable time due to the much more complicated production procedures; in addition, in the traditional design, the height of pole column is normally lower than the height of coils after the winding operation, so that the accomplished coils would be exposed easily without the existence of any structure suitable for insulation-protected coil, and hence the operating efficiency will be affected easily by external factors, as a matter of fact we might say that it is not an optimum structure at all.

### SUMMARY OF THE INVENTION

The present relates to an improvement on the stator structure of external-rotor motor, wherein its consists of the start-up coils and operating coils wound into the silicon steel race, wherein the main structure has a silicon steel race consisting of four sets of start-up coils and four sets of operating coils wound-up thereto; and the said silicon steel race comprises a plurality of insulation columns and rabbets, and each insulation column has a high wall formed at its front end thereof, and wherein there is one set of coil being wound-up respectively at each side of datum point of axial hole of the said start-up coil respectively with the utilization of two rabbets positioned apart from the said datum point in an equal-length distance thereto, so that four sets of start-up coils are hence formed at the internal surface of said silicon steel race by means of two corresponding sets of cross coils; in addition, there are one set of operating coil constructed at the top and bottom of datum point respectively with the utilization of two rabbets positioned apart from the said datum point in an equal-length distance thereto, so that four sets of operating coils are hence formed at the top and bottom side by means of two corresponding sets of cross coils, and thereat the said four sets of operating coils are covering onto the external edge of said start-up coils, where it is constructed as a twin-well structure, so that both the start-up coils and operating coils will be uniformly distributed within the wall of said silicon steel race and in this way it will be able to be insulation-protected by the wall of said insulation columns and hence achieve a practical objective in uniform safety and saving the resistance coils quantity used in the enamelled wire in addition to the reduction of production costs as well as the saving in electricity consumption.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a structural stereogram of the silicon steel race in accordance with the present invention;

FIG. 2 is a plan of the silicon steel race in accordance with the present invention;

FIG. 3 is a schematic view showing the winding of the primary start-up coil in accordance with the present invention;

FIG. 4 is a schematic view showing the winding of the secondary start-up coil in accordance with the present invention;

FIG. 5 is a schematic view showing the winding of the third start-up coil in accordance with the present invention;

FIG. 6 is a schematic view showing the winding of the fourth start-up coil in accordance with the present invention;

FIG. 7 is a schematic view showing the extension coil in accordance with the present invention;

FIG. 8 is a schematic view showing the winding of the primary operating coil in accordance with the present invention;

FIG. 9 is a schematic view showing the winding of the secondary operating coil in accordance with the present invention;

FIG. 10 is a schematic view showing the winding of the third operating coil in accordance with the present invention;

FIG. 11 is a schematic view showing the winding of the fourth operating coil in accordance with the present invention; and

FIG. 12 is a schematic view showing the assembly of stator and rotor in accordance with the present invention.

### DETAILED DESCRIPTION OF THE PREFERRED EMBODIMENT

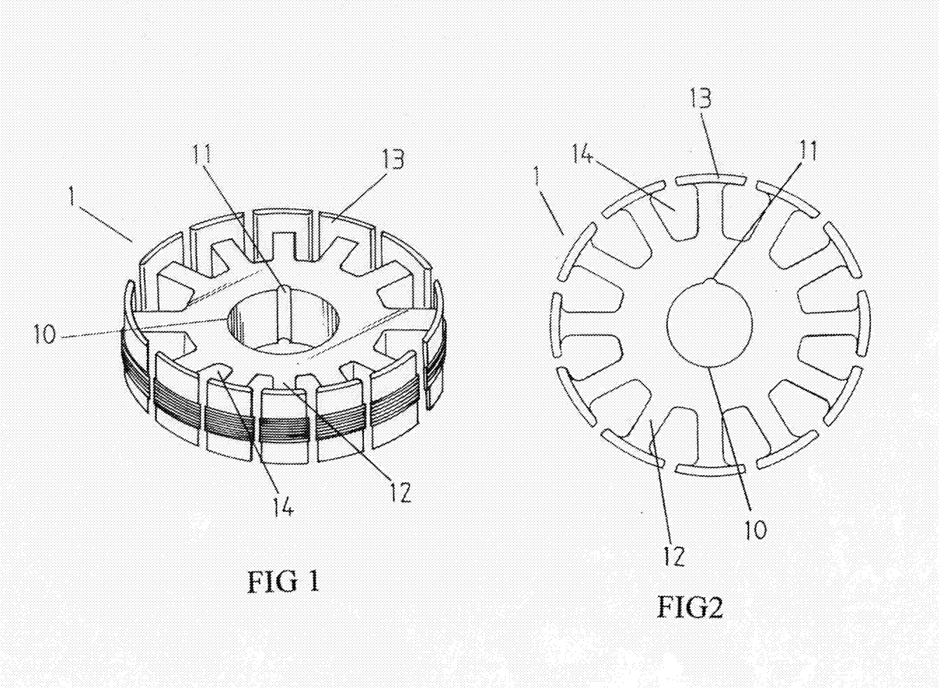

With reference to FIG. 1, the silicon steel race 1 in accordance with the present invention consists of four sets of start-up coils 2 and four sets of operating coils 3, wherein the silicon steel race 1 has a axial hole 10 positioned at the center portion, and thereat there is a datum point 11 formed at the upper end of said axial hole 10, and more over there are even numbers of insulation column 12 formed at its external edge thereof, and in addition, a high wall 13 is formed at the front end of said insulation column 12, where a rabbet 14 has been constructed in-between each of insulation column 12, in which the quantity of said rabbet 14 is equal to the quantity of said insulation column 12. (as shown in FIG. 2) respectively.

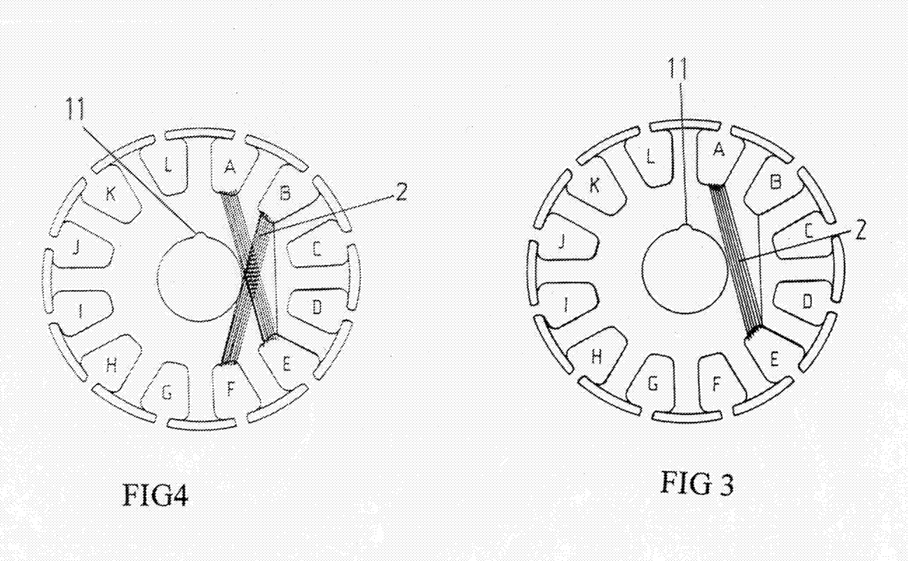

Please refer to FIG. 3, it shows the winding procedure and method for the start-up coil 2 according to the present invention, at first, winding the front end of the resistance enamelled wire to be entered into a rabbet A positioned at the nearest datum point 11, and then exited from a rabbet E within a specific distance, and hence the winding operation for the primary start-up coil set 2 has been accomplished, and again, immediately winding and entering it into one adjacent rabbet B, in the clockwise direction, and then exiting out of one adjacent rabbet F with the same distance apart from the two rabbets of the primary start-up coil set, therefore the winding operation for the secondary start-up coil set has been accomplished, where the resistance enamelled wire used for these two start-up coils have been wound-up in a clockwise direction, thereat the accomplished coils have a cross link coil type (as shown in FIG. 4).

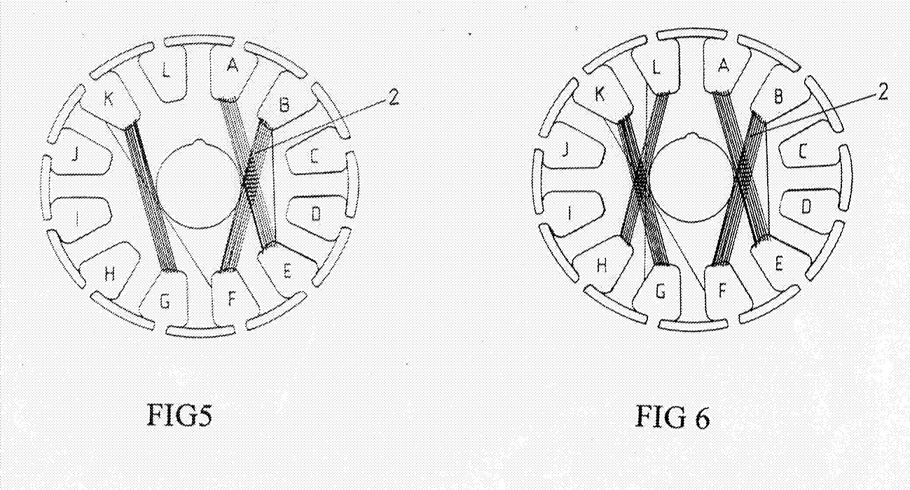

Again, immediately turn the said silicon steel race 1 to a 180 degrees angle, having the resistance enamelled wire coils turned to the other side of the datum point 11 in such a way that one corresponding rabbet K which is parallel to the rabbet A and one corresponding rabbet G which is parallel to the rabbet E would become the entering rabbet and the exiting rabbet respectively, furthermore, it is necessary to perform the winding operation in anticlockwise direction accordingly; afterwards, the anticlockwise winding operation should be moved to the area of adjacent rabbet L and rabbet H in order to acquire two sets of start-up coils with cross link coil type, and in this way it is applicable to generate four sets of start-up coils with a cross link coil type (as shown in FIGS. 5, 6).

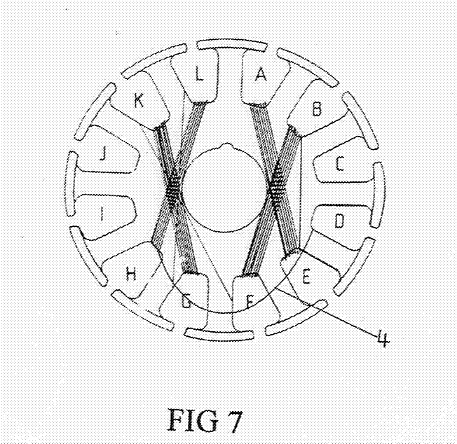

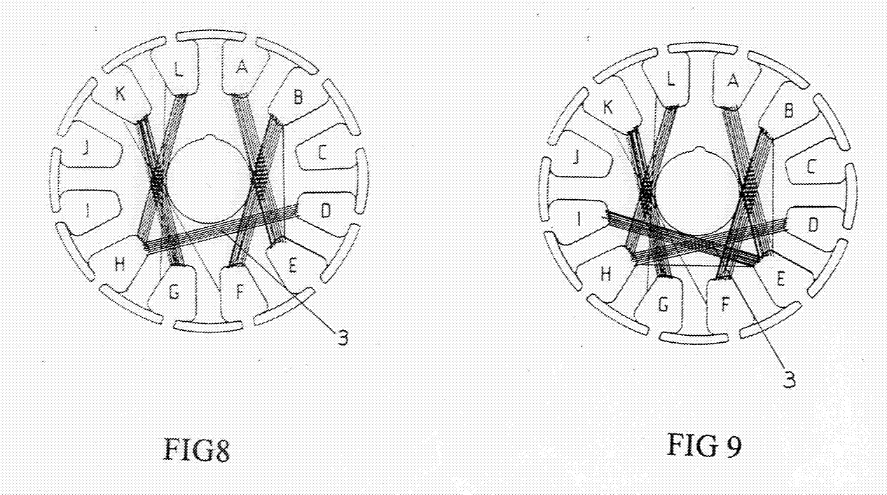

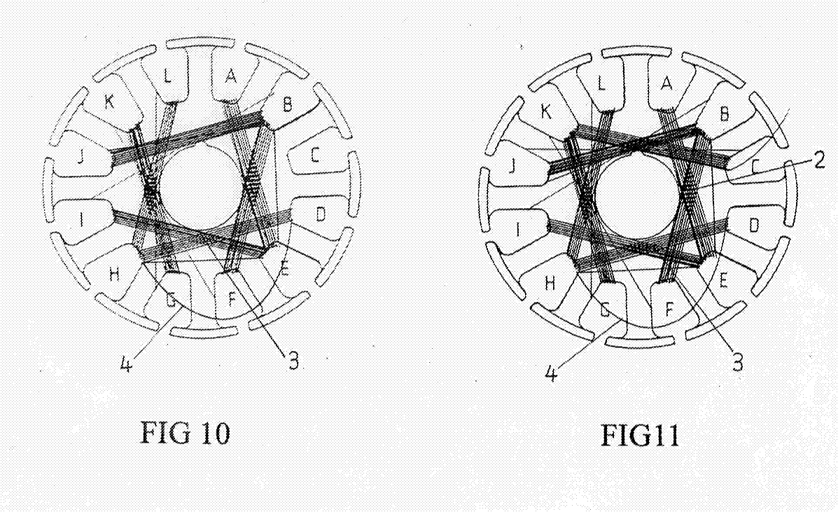

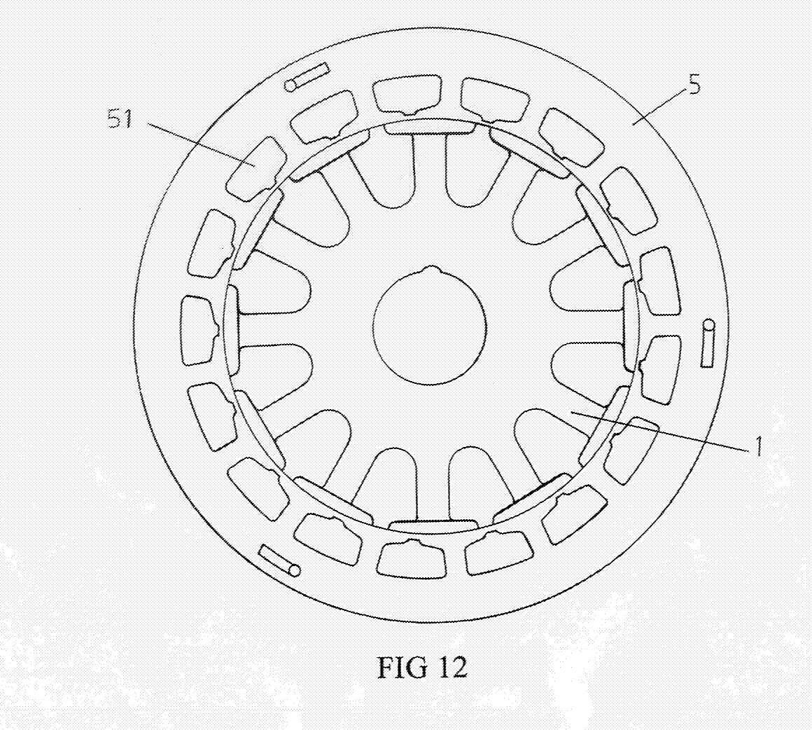

With reference to FIG. 7, by the time while four sets of start-up coils 2 have been accomplished, starting to wind-up the resistance enamelled wire over the axle center with the preservation of an extended coil 4, and then performing the operation for another four sets of operating coils 3, wherein the said operating coil 3 consisting of the resistance enamelled wires 2 which is exiting from rabbet H will be wound-up to enter into rabbet D so as to accomplish the winding operation for the primary set of said operating coil 3, and again, the wire will be wound-up and entered into the corresponding rabbet E and then exited from adjacent rabbet I for accomplishing the winding operation for the secondary set of said operating coil 3, and the said two sets of operating coils also have a cross link coil type (as shown in FIGS. 8, 9). The wire exiting from rabbet I would enter into rabbet B and then exit from rabbet J so as to accomplish the wing operation for the third set of said operating coil 3, as to the fourth set of said operating coil 3, it is necessary to get the wire exiting from rabbet J and have it being entered into an adjacent rabbet C, in the clockwise direction, and then being exited from the rabbet K so that it is able to accomplish the winding operation for the fourth set of operating coil 3 and in this way it is able to configure two sets of start-up coils with a cross link coil type, so that all four sets of operating coil 3 with the cross link coil type have been would up successfully which are covering over the external edge of said start-up coil 2, so that both the start-up coils 2 and operating coils 3 will be uniformly distributed within the wall of said silicon steel race and in this way it will be able to be insulation-protected by the said wall 13 of silicon steel race and hence achieve a practical objective in uniform safety and saving the coils quantity used in addition to the reduction of production costs as well as the saving in electricity consumption (as shown in FIGS. 10, 11), additionally, the accomplished stator could be combined together with a rotor 5 directly (as shown in FIG. 12). The rotor 5 is formed with seventeen or twenty-two grooves 51.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An improvement on the stator structure of external-rotor motor, wherein the main structure has a silicon steel race consisting of four sets of start-up coils and four sets of operating coils wound-up thereto; and the said silicon steel race comprises a plurality of insulation columns and rabbets, and each insulation column has a high wall formed at its front end thereof, wherein there is one set of coil being wound-up respectively at each side of datum point of axial hole of the said start-up coil respectively with the utilization of two rabbets positioned apart from the said datum point in an equal-length distance thereto, so that four sets of start-up coils are hence formed at the internal surface of said silicon steel race by means of two corresponding sets of cross coils; in addition, there are one set of operating coil constructed at the top and bottom of axle center of said silicon race respectively with the utilization of two rabbets positioned apart from the said datum point in an equal-length distance thereto, so that four sets of operating coils are hence formed at the top and bottom side by means of two corresponding sets of cross coils, and thereat the said four sets of operating coils are covering onto the external edge of said start-up coils; whereby both the start-up coils and operating coils will be uniformly distributed within the wall of said silicon steel race and in this way it will be able to be insulation-protected by the said wall in such a way that it could be combined together with a rotor directly.

2. An improvement on the stator structure of external-rotor motor as claimed in claim 1, wherein, the four sets of start-up coils are sequentially entering into the first rabbet aside the axial datum point of said silicon steel race and exiting from the fifth rabbet, and entering into the second rabbet then exiting from the sixth rabbet, and entering into the eleventh rabbet then exiting from the seventh rabbet, and then entering into the twelfth rabbet then exiting from the eighth rabbet.

3. An improvement on the stator structure of external-rotor motor as claimed in claim 1, wherein, the four sets of operating coils are sequentially entering into the fourth rabbet then exiting from the eighth rabbet, and entering into the fifth rabbet then exiting from the ninth rabbet, and entering into the second rabbet then exiting from the tenth rabbet, and then entering into the third rabbet then exiting from the eleventh rabbet.

4. An improvement on the stator structure of external-rotor motor as claimed in claim 1, wherein, the four sets of operating coils are sequentially entering into the fourth rabbet then exiting from the eighth rabbet, and entering into the fifth rabbet then exiting from the ninth rabbet, and entering into the second rabbet then exiting from the tenth rabbet, and then entering into the third rabbet then exiting from the eleventh rabbet.

5. An improvement on the stator structure of external-rotor motor as claimed in claim 1, wherein, the four sets of start-up coils are wound-up in clockwise sequence.

6. An improvement on the stator structure of external-rotor motor as claimed in claim 2, wherein, the four sets of start-up coils are wound-up in clockwise sequence.

7. An improvement on the stator structure of external-rotor motor as claimed in claim 1, wherein, the four sets of operating coils are wound-up in anti-clockwise sequence.

8. An improvement on the stator structure of external-rotor motor as claimed in claim 3, wherein, the four sets of operating coils are wound-up in anti-clockwise sequence.

9. An improvement on the stator structure of external-rotor motor as claimed in claim 4, wherein, the four sets of operating coils are wound-up in anti-clockwise sequence.

10. An improvement on the stator structure of external-rotor motor as claimed in claim 1, wherein, the outer circumference of the silicon steel race is formed with twelve insulation columns and twelve rabbets.

11. An improvement on the stator structure of external-rotor motor as claimed in claim 1, wherein, the structure for the rotor is constructed with seventeen grooves.

12. An improvement on the stator structure of external-rotor motor as claimed in claim 1, wherein, the structure for the rotor is constructed with twenty-two grooves.
